(19) United States
(12) Patent Application Publication
(10) Pub. No.: US 2021/0362567 A1
(43) Pub. Date: Nov. 25, 2021

(54) ZONE ISOLATION AIR FLOW SYSTEM FOR SEMI-TRAILER REEFERS

(71) Applicant: Ronald Koelsch, Roscommon, MI (US)

(72) Inventor: Ronald Koelsch, Roscommon, MI (US)

(21) Appl. No.: 17/398,062

(22) Filed: Aug. 10, 2021

Related U.S. Application Data
(63) Continuation-in-part of application No. 15/904,621, filed on Feb. 26, 2018.
Application No. 15/904,621 is a continuation-in-part of application No. 15/283,710, filed on Oct. 3, 2016, now abandoned.
(60) Provisional application No. 62/245,366, filed on Oct. 23, 2015.

(51) Int. Cl. B60H 1/32

(52) U.S. Cl. CPC B60H 1/3226

(57) ABSTRACT

Zone isolation of the all-electric semi-trailer reefer cold chambers completes the combination of refrigeration, battery, and solar technologies. Temperature controlled flow of cold air improves refrigeration efficiency and makes it possible to use solar panels to exclusively power a zero-emissions semi-trailer sized reefer.

### CROSS-REFERENCE TO RELATED APPLICATIONS

This application is a utility application claiming priority from U.S. Utility patent application Ser. No. 15/904,621, filed Feb. 26, 2018, which claims priority from U.S. Utility patent application Ser. No. 15/283,710, filed Oct. 3, 2016, which claims priority from U.S. Provisional patent application Ser. No. 62/245,366, filed Oct. 23, 2015.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

The instant invention relates to the efficiency and environmental impact of semi-trailer reefers. These reefers have refrigeration systems called transport refrigeration units (TRU) mounted on the front of the trailer that are the source of cooling the cold chambers integral to the sides, floor, and ceiling of the semi-trailer. Components of the TRU are the motor, compressor, condenser, and evaporator.

Typical multi-zone semi-trailer reefers existing in the field have a cold chamber layout containing multiple temperature zones. Zone 1 (Z1) typically includes a freezer; Zone 2 (Z2) is typically a refrigerated compartment; Zone 3 (Z3) is typically a second refrigerator or an ambient temperature chamber for dry goods. The TRU evaporator cools Z1 while Z2 and Z3 use remote evaporators.

Prior art semi-trailer reefers regulate the temperature of Z2 and Z3 by sourcing refrigerant from the evaporator of Z1 and supplying the refrigerant to evaporators of the adjacent temperature zones, Z2 and Z3. Refrigerant is moved through the system via a 60-foot flow closed loop connecting the freezer refrigerant source in Z1 to remote evaporators in Z2 and Z3. This configuration is problematic because the consequent refrigerant transfer from Z1 required when Z2 and/or Z3 operate in high-demand mode, compromises Z1 freezer temperatures.

Z1 host freezer chambers are typically set to run at a temperature of −20° F. to 0° F. Due to the refrigerant transfer from Z1 required when the Z2 and Z3 remote evaporators require cooling, freezer temperatures rise, and critical freezer set points cannot be maintained without high duty cycle times around 70%. The prior art does not adequately compensate for the freezer performance loss associated with refrigerant transfer. The result is poor efficiency.

Refrigeration efficiency is expressed as coefficient of performance (COP). COP is the cooling power output of the TRU divided by the power into the TRU. A semi-trailer reefer fully loaded with 40,000 pounds of frozen and refrigerated food on a warm day must have a cooling power on the order of 25 BTU/HR@−10 F and 65 BTU/HR@35 F respectively to maintain the set point temperatures. The COP then determines how much input power is needed to operate the TRU.

Present state of the art semi-trailer reefers are typically powered by diesel engines that power the compressor, fans and remote evaporators. These systems pose energy efficiency and emissions obstacles. Present diesel driven systems typically require 18 kW (24 horsepower) of input power to make 18 kW (65 BTU/HR) of cooling power @ 35° F. and use a 50% duty cycle. Their COP is only 1. In one hour, they typically use 9 kWh of energy assuming they can keep the load of food cold with a 50% duty cycle. Diesel TRUs emit 50 tons of greenhouse gas (GHG) annually along with nitrogen oxides, reactive organic gases and particulate matter containing poisonous black carbon.

Prior art has been unable to achieve the efficiency required to operate a semi-trailer sized TRU without reliance on fossil fuel, and no prior art has been able to meet a zero emissions standard.

Prior art semi-trailer reefers also use hot refrigerant gas from remote evaporators to provide heated air to refrigerator chambers to keep refrigerated food from freezing when the outside ambient air temperature is below freezing, or to defrost evaporators. This is problematic because defrosting the evaporators with hot refrigerant gas causes cooling chamber temperatures to rise and increases the duty cycle. Efficiency is further degraded. Under this diesel configuration, the only battery used in the reefer is a small 600 watt-hour battery to start the diesel engine and power the TRU control computer.

Prior art non-diesel semi-trailer reefers have attempted to improve TRU energy efficiency and reduce emissions using a large 48 kWh battery that solely powers electric motors driving the TRU compressor, fans and computer control system, thus replacing the diesel engine. The integration of solar panels electrically charges the battery. However, these semi-trailer reefers suffer from a low COP and short run times that limit their usefulness for food delivery logistics. Run times are determined by the total energy stored in the battery versus the energy consumption of the TRU.

Prior art battery powered TRUs typically use approximately 8 kW of power, and rely on refrigerant transfer to remote evaporators causing a low COP. They use power company grid AC electricity to charge the battery and run the TRU when it is stationary. The prior art has been unable to achieve sustainable symbiosis between the energy demands of the TRU and the energy output produced by non-diesel energy sources. The COP is too low, and the duty cycle is too high to achieve sufficient run times from current battery technologies.

Prior art using remote evaporators have attempted to do so in combination with conventional refrigerant transfer systems, treating temperature fluctuations as a component of the refrigerant transfer loop. Prior art does not adequately compensate for the energy stress placed on the system by the transfer of refrigerant to remote evaporators. Prior art battery operated transfer refrigeration units without zone control are known from U.S. Pat. No. 8,935,933.

### BRIEF SUMMARY OF THE INVENTION

A zero-emission, energy efficient, zoned, semi-trailer reefer equipped with a refrigeration and airflow system energized with solar power and battery power in combination. The reefer is equipped with mixing chambers, including ductwork and control gates, wherein the zones are cooling chambers integral to the semi-trailer walls, ceiling, and floor.

### BRIEF DESCRIPTION OF THE SEVERAL VIEWS OF THE DRAWING

FIG. 1 is a full upper side view in perspective of the all-electric solar battery powered semi-trailer reefer showing predetermined cold chamber zone isolation.

FIG. 2 is a full lower side view in perspective of the inside of the semi-trailer reefer of FIG. 1 showing cold freezer air being routed to the refrigerators and warm refrigerator air being returned to the freezer evaporator.

FIG. 3 is an illustration showing cold air being routed from the freezer to the refrigerator and warm refrigerator air being routed to the freezer evaporator.

FIG. 4 is a full front view of an all-electric transport refrigeration unit.

FIG. 5 is a full rear view of the reefer of FIG. 1 showing the rectangular airflow ducting recessed into the ceiling of a refrigeration chamber.

FIG. 6A is a full front view of the evaporator box showing airflow through the evaporator and mixing chamber.

FIG. 6B is a cross sectional view through line 6B 6B of FIG. 6A.

FIG. 7 is a schematic showing the DC micro-grid with solar panel equipped semi-trailer reefers ganged together.

### THE INVENTION

The instant invention creates a cold air delivery system new to the art, which significantly reduces energy expenditure by using airflow as an alternative to refrigerant transfer. Using a combination of battery power, solar power, and airflow control facilitated by fans, ducts, gates, and air temperature controllers, COP is increased to a critical point whereby alternative energy sources can power the TRU for run-times previously unachievable in the art.

The instant invention capitalizes on this energy efficiency by powering the entire semi-trailer reefer refrigeration and airflow system with a solar and battery combination that does not rely on internal combustion engine power such as a diesel. Moreover, battery longevity is achieved by using solar panels that may be linked to charge batteries in a micro-grid format and by employing a regenerative wheel generator as a back-up power source.

This semi-trailer reefer system combines refrigeration, battery and solar technologies in a way that optimizes energy usage and eliminates emissions as defined by The California Air Resources Board (CARB). The advantages of this all-electric semi-trailer reefer over the diesel can be summarized in the table below.

| | Input | Cooling | Duty Cycle | Run | Solar | Greenhouse |
|---|---|---|---|---|---|---|
| | Power | Power | in | Energy | Energy | Gases |
| | Watts | Watts@35° F. | Percent | Watt-hours | Watt-hours | Tons |
| Diesel | 18000 | 18000 | 50 | 9000 | 0 | 50/yr. |
| Electric | 8000 | 18000 | 25 | 2000 | 2000+ | 0 |

The instant air delivery system, called zone isolation, does not rely on refrigerant transfer to cool the multiple refrigeration chambers composed of the semi-trailer walls, floor, and ceiling. It instead uses an airflow control system that extracts cold air directly from a post-evaporator colder air chamber and exchanges it for warmer air from the refrigerator chambers. The system brings the warmer refrigerator air forward to the colder freezer chamber, and then directs it to a mixing chamber isolated from the freezer evaporator.

The warm return air from the refrigerator chamber is mixed with the cold post-freezer evaporator air in the mixing chamber. The cold-mixed air is then directed to flow back to the Z2 or Z3 refrigerator chamber to lower its temperature. Similarly, this airflow system improves performance in single-refrigeration chamber semi-trailer reefer by delivering post-evaporator cold air to the rear of the refrigeration chamber. This maintains a more even air temperature distribution in the refrigeration chamber.

In both instances, the instant design allows faster refrigerator cooling response, improves the performance of the overall refrigeration system, and decreases the refrigeration duty cycle. The COP of this all-electric, zone isolation semi-trailer reefer is greater than 2.25 compared to 1.0 for the diesel semi-trailer reefer.

The instant airflow system of ducting and pass-through openings is sequenced on a temperature control basis to bring cold air from the freezer to the refrigerator as needed. It is delivered to isolated refrigeration zones, Z2 and Z3, to maintain a single temperature or multiple temperatures across multiple zones.

Zone isolation airflow means refrigerant flow is uncompromised in Z1. The freezer temperature deficiencies suffered by the prior art are eliminated. Consequently, energy is conserved, higher operating efficiency is achieved, and Z1 continuously operates at peak performance levels.

Moreover, the instant invention's zone isolation system eliminates the use of remote evaporators and the high duty cycle problems associated with defrosting the evaporators with hot refrigerant gas. The instant system alternatively uses electric heater rods to quickly provide hot air, when required, to defrost the single freezer evaporator or to maintain above freezing refrigerator temperatures.

The instant airflow system creates a low-duty cycle, so it is not prone to evaporator frosting. However, if defrosting of the Z1 evaporator is required, the electric heater rods can efficiently defrost the unit without causing freezer chamber temperatures to rise. It therefore consumes less energy than the prior art while maintaining better temperature control.

The instant invention further reduces energy consumption and eliminates the fossil fuel emissions produced by the prior art. Unlike prior art TRUs, which draw power from a diesel engine to operate cooling zones, the instant invention powers compressor and fan electric motors solely by battery. An electric motor drives the refrigeration compressor and fans, such that air can be extracted directly from a post-evaporator cold-air mixing chamber located in Z1 for distribution to isolated cooling compartments Z2 and Z3.

The instant invention further solves power sustainability issues proposed by the prior art by connecting the battery to a solar panel embodiment. Unlike the prior art, this invention uses an integrated system that lowers energy expenditure within the TRU to levels that can be recaptured by an integrated solar panel. Battery longevity is therefore increased beyond what is achievable under the prior art.

During a typical all-electric semi-trailer reefer food delivery route, a 120 kWh battery now provides 60 hours of run time by itself and upwards of 70 hours including the additional energy made by the solar panel. This makes the all-electric solar semi-trailer reefer run time comparable to that of a diesel with a 50-gallon fuel tank.

When multiple zone isolation, all-electric semi-trailer reefers are equipped with solar panels, the configuration supports fleet charging. When they are parked in a common location, such as a warehouse yard used for loading or staging, they can be plugged into a common power network, thereby ganging them into a direct current micro-grid formation such that ones needing charging can draw power from their own solar panel or the solar panels of other fully charged semi-trailer reefers. This fleet charging method does not require central energy storage. The all-electric semi-trailer reefers use the solar-generated power immediately.

A central energy storage battery can be included in this power arrangement along with land based auxiliary solar panels. This configuration allows the fleet of solar-powered semi-trailer reefers to become a local solar generation station. These reefers can operate completely separate from the power company electrical grid commonly called shore power.

The instant invention further eliminates battery sustainability problems by using an optional back-up wheel generator as a reserve electric power source to charge the battery. Adjusting the voltage regulator so the system is purely regenerative eliminates increased semi-tractor fuel consumption and emissions. An accelerometer controls the voltage regulator, so power is only generated during deceleration. There is no additional drag on the tractor during acceleration and cruise. The system can be programmed to generate continuous power during an emergency low battery charge condition whenever the speed of motion is above a set minimum speed.

While the instant invention is here described as a semi-trailer reefer it is applicable to other reefers such as an intermodal transport container.

### Detailed Description of the Drawings and Invention

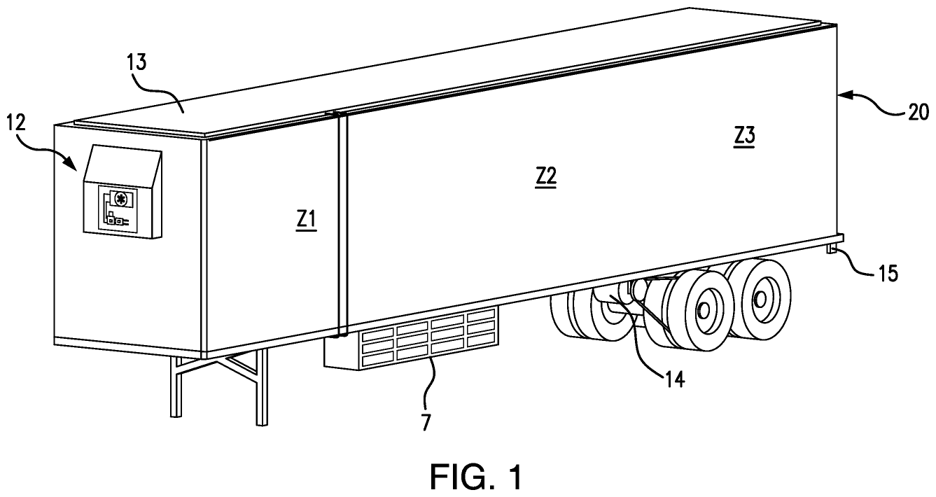

The zone isolation solar battery powered semi-trailer reefer (20) layout of the instant invention is shown in FIG. 1 where zone one (Z1) is a freezer, zone two (Z2) a refrigerator and zone three (Z3) may be a second refrigerator or an ambient temperature chamber for dry goods.

The freezer (Z1) requires the most cooling to hold sub-freezing temperatures. Present art semi-trailer reefers take refrigerant from the Z1 freezer evaporator and move it to remote evaporators in Z2 and Z3 whenever they demand cooling based on temperature. Z2 and Z3 take priority over Z1, and freezer performance suffers putting frozen product at risk. This invention prevents this degradation of freezer performance by totally eliminating the remote evaporators and refrigerant flow loop from the freezer Z1 to remote evaporators in Z2 and Z3.

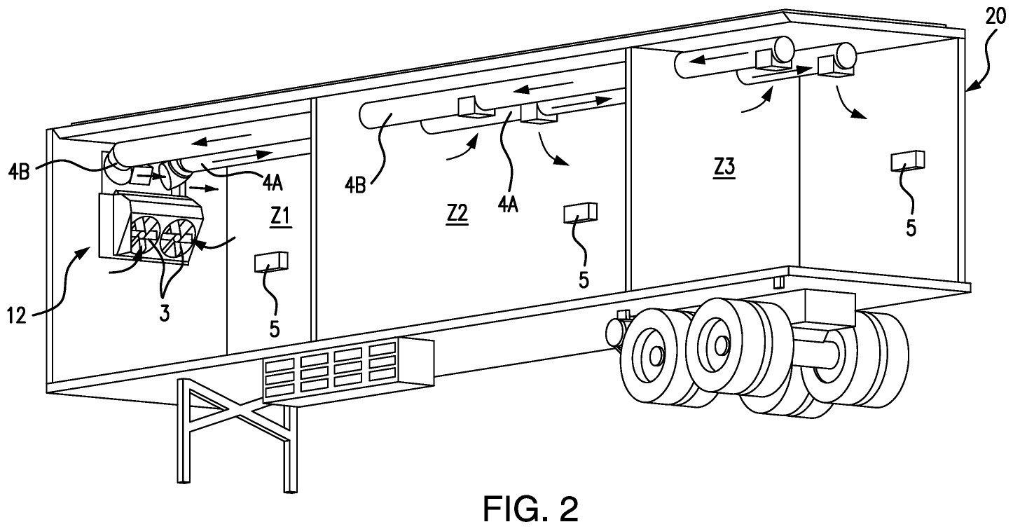

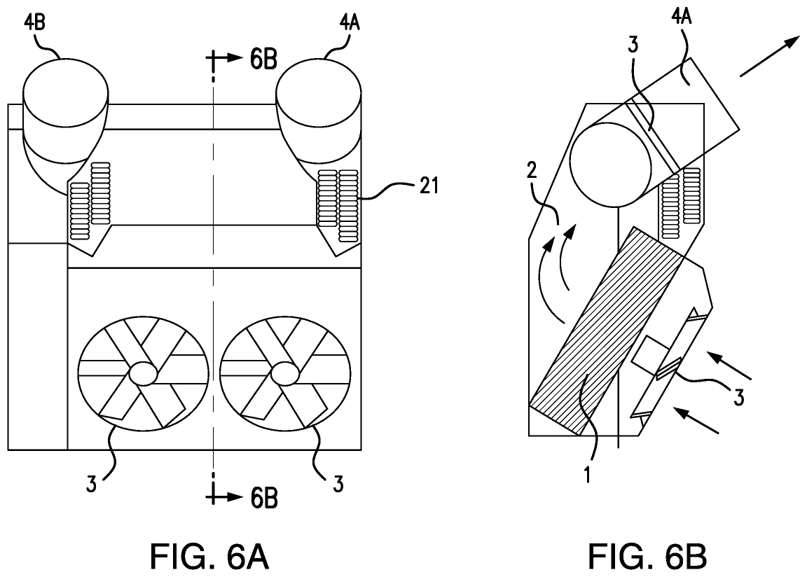

Instead of taking refrigerant from the Z1 evaporator (1), this invention as illustrated in FIG. 2, FIG. 6A and FIG. 6B, draws cold air from the freezer Z1 post evaporator mixing chamber (2), delivers it through duct (4A) to the refrigerator chambers Z2 and Z3 to maintain their temperatures. The warmer refrigerator air is returned via duct (4B) to the freezer evaporator (1) for cooling thus completing the U-shaped loop of airflow.

Each zone is controlled such that Z1 has priority, refrigerant is never removed from the Z1 evaporator, and the critical freezer temperature is strictly maintained. Z1 temperature control is improved and the TRU (12) runs less time giving the refrigeration system a lower duty cycle.

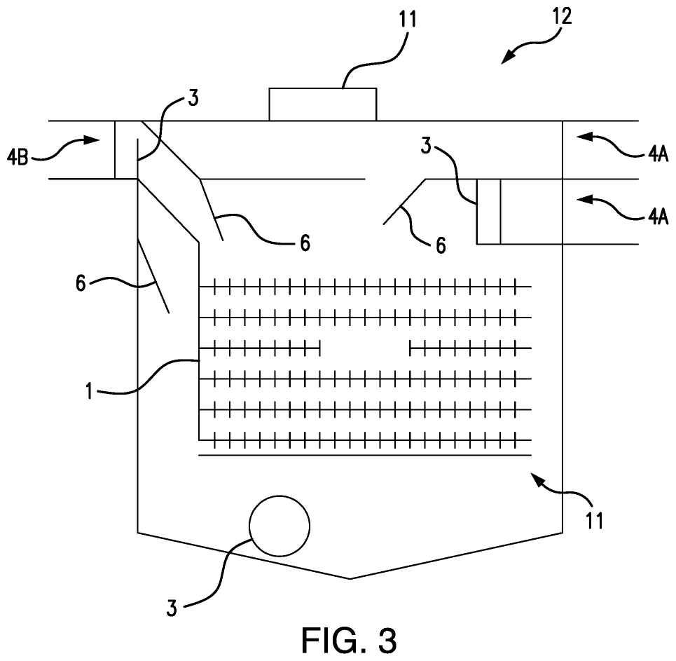

Colder air is routed from the freezer Z1 to the refrigerators Z2 and/or Z3 via air duct (4A) and the warmer air from the refrigerators Z2 and/or Z3 is returned via air duct (4B) to the freezer Z1 using the system of fans (3), ducting (4A) and (4B), temperature sensors (5) and control gates (6) as illustrated in FIG. 2 and FIG. 3. The locations of the control mixing gates (6) are shown in FIG. 3. The arrows in FIG. 2 show the direction of airflow. This method of cooling the refrigerator chambers is faster acting and more efficient than pumping refrigerant to remote evaporators in the refrigerators, resulting in a lower duty cycle.

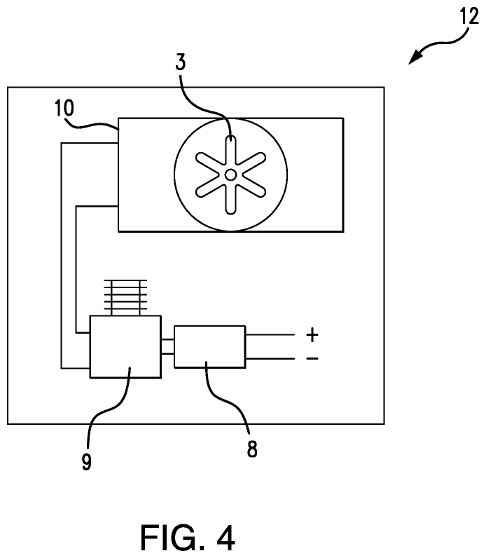

Lower duty cycle means less cooling energy is required to maintain the set point temperatures of the freezer Z1 and refrigerators Z2 and Z3. The 8 kW power draw on the battery (7) in FIG. 1, by the direct current (dc) electric motor (8) that drives the refrigeration compressor (9) and condenser (10) of the TRU (12), shown in FIG. 4, and the dc electric motors of the airflow fans (3) only occurs 25% of the time. The electric energy used to run the refrigeration system for one hour is only 2 kWh because of the low 25% duty cycle achieved by this zone isolation airflow system.

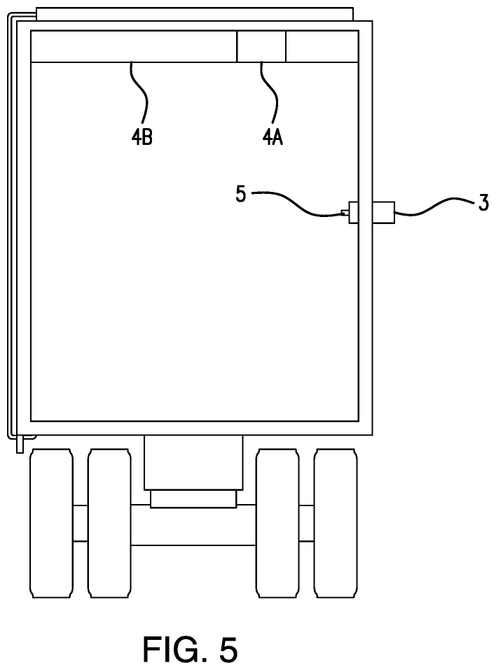

The airflow ducts (4A) and (4B) can be recessed into the ceiling of the refrigeration chambers. Both the air duct (4A) routing colder air from the freezer Z1 to the refrigerators Z2 and/or Z3 and the air duct (4B) returning warmer air from the refrigerators Z2 and/or Z3 to the freezer Z1, become rectangular shaped ducts as shown in FIG. 5. The rectangular ducts (4A) and (4B) fit into semi-trailer reefers without modifying standard-insulated ceilings.

Also shown in FIG. 3, are electric heating elements (11) in the evaporator area that are used to provide refrigerator heating in cold ambient conditions. They are also used to defrost the evaporator (1). This electric defrost adds to the efficiency of the all-electric solar battery powered semi-trailer reefer with zone isolation. The electric defrost is more efficient and faster acting than current defrost systems that use hot refrigerant gas.

The zone isolation system of the instant invention brings the one-hour energy consumption of an 18 kW at 35° F. cooling power, battery-powered TRU (12) down from 8 kWh to 2 kWh. Zone isolation makes it possible for the first time to use solar panels (13), shown in FIG. 1, as the sole power source for mobile refrigeration systems such as this zone isolation all-electric solar battery powered semi-trailer reefer (20).

Semi-trailers have upwards of 400 square feet of roof area available. Present solar panel efficiency will produce 4 kW or more of solar-electrical power from this area. Storing ten hours of solar panel produced power in the battery (7) of the battery-powered semi-trailer reefer provides 40 kWh of electrical energy, more than enough energy to run the battery-powered TRU (12) on a typical delivery route. This solar-battery-powered TRU (12) has no exhaust tailpipe and produces zero emissions during operation as certified by California Air Resources Board (CARB).

A wheel generator system (14) is shown in FIG. 1 that only makes power during deceleration in a regenerative fashion, preserving the zero-emissions feature of this invention. It can be turned on automatically to continuously produce power during emergency low-battery charge situations to charge the battery (7) that runs the refrigeration system including the electric motor (8) and fans (3) and charge the battery (7). Likewise, an optional charger plug-in socket (15) is shown in FIG. 1 where either an onboard or land-based battery charger/auxiliary power unit can be used to charge the battery that runs the refrigeration system.

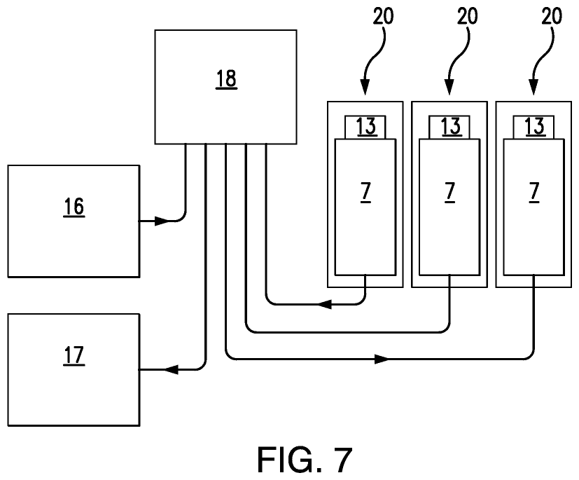

An electric power generation plant comprising a fleet of, for example three, zone isolation solar battery powered semi-trailer reefers (20) equipped with batteries (7) and solar panels (13), are ganged together in a charging network to form a local dc micro-grid as illustrated in FIG. 7. When these solar powered reefers are parked in the warehouse yard for loading or staging, they can be plugged into the micro-grid managed by the central control system (18). This fleet of solar reefer trailers becomes a local solar-power generation plant where individual reefers that need battery charging get power from not only their own solar panel (13) but also the solar panel from all other solar semi-trailer reefers that have fully charged batteries. This fleet charging method does not require central energy storage. The all-electric semi-trailer reefers use the solar-generated power immediately.

Charging can include central energy storage where each solar semi-trailer reefer battery (7) is additionally charged from a central storage battery (17) and from each fully charged reefer's solar panel (13) and an auxiliary solar panel (16). The central charge control unit (18) can manage this central energy storage method. Electric power from the ac power company grid, known as shore power, is no longer required and the fleet of zone isolation solar battery powered all-electric semi-trailer reefers (20) can operate solely on solar power.

What is claimed is:

1. A zero-emission, energy efficient, zoned, semi-trailer reefer equipped with a refrigeration and airflow system energized with solar power and battery power in combination;
said reefer equipped with mixing chambers, including ductwork and control gates, wherein said zones are cooling chambers integral to said semi-trailer wall, ceiling, and floor.

2. A battery powered TRU with zone isolation as claimed in claim 1 wherein, in addition, there is a battery that powers said TRU refrigeration system that consumes less than 18 kW of electrical power while producing 18 kW of cooling power at 35 degrees Fahrenheit with a coefficient of performance greater than 2.25.

3. A battery powered TRU as claimed in claim 2 wherein, in addition, there is a compressor driven by a motor selected from the group consisting of:
i) direct current brushed motor;
ii) a direct current brushless motor,
iii) an induction alternating current motor with a direct current to alternating current converter.

4. A battery powered TRU as claimed in claim 3 wherein the motor can be a separate component from the compressor or integral with the compressor.

5. A battery powered TRU as claimed in claim 2 wherein a solar panel is used to charge said battery that runs said TRU refrigeration system.

6. A battery powered TRU as claimed in claim 5 wherein said solar panel is a power generation source and said generated power is sufficient to supply all the power necessary to run said refrigeration unit.

7. A battery powered TRU as claimed in claim 1 wherein there is, in addition, a backup wheel generator system that only makes power during deceleration of a vehicle that is towing said backup wheel generator system.

8. A battery powered TRU as claimed in claim 1 wherein said battery powered TRU is programmed to continuously produce power during emergency low-battery voltage situations.

9. An electric power generation plant comprising a fleet of battery powered TRUs as claimed in claim 1 that are equipped with solar panels, ganged together in a charging network.

10. A battery powered TRU as claimed in claim 1 wherein ducts are recessed into a ceiling of said refrigeration zones.
